(19) United States
(12) Patent Application Publication
(10) Pub. No.: US 2025/0367677 A1
(43) Pub. Date: Dec. 4, 2025

(54) MACHINE BLADE

(71) Applicant: BE MASCHINENMESSER GMBH & CO. KG, Spreenhagen (DE)

(72) Inventors: Matthias FLEISCHHAUER, Steinhöfel (DE); Justin SMEJKAL, Fürstenwalde (DE)

(21) Appl. No.: 18/706,807

(22) PCT Filed: Nov. 4, 2022
(86) PCT No.: PCT/EP2022/080854

§ 371 Date: May 2, 2024

(30) Foreign Application Priority Data
Nov. 4, 2021 (DE) 102021128768.5

(51) Int. Cl. B02C 18/20; B02C 18/24

(52) U.S. Cl. CPC B02C 18/20; B02C 18/24

(57) ABSTRACT

The invention relates to a machine blade comprising a cutting body and a fastening portion for fastening the cutting machine blade to a rotary drive. The cutting body has: a central area defined by at least two lateral surfaces that extend approximately parallel to one another; and edge regions adjacent thereto, the thickness of the cutting body in each edge region decreasing from the central area towards an associated edge of the cutting body. Furthermore, the cutting body has at least one blade comprising a cutting edge at an edge of the cutting body that is in front with respect to a direction of rotation during operation. The machine blade is designed to be rotationally driven about an axis of rotation during operation. A radius of the machine blade extends from the axis of rotation to an outer edge of the machine blade.

The invention relates to a machine blade for food production.

In the food processing industry, various raw materials in the form of meat, bacon, fruit, vegetables, milk, etc. are used to produce sausage meat with the addition of spices and additives, from which finished products such as various types of sausage are then made after further processing. Cutters are often used for this purpose. These are types of machines that have been in use for decades.

In a cutter, the raw food ingredients, additives and spices are chopped by rotating blades in a rotating bowl and emulsified as required. In special cooking cutters, the contents of the bowl to be processed can also be thermally treated.

Over the course of time, various blade shapes have been developed depending on the products to be produced, which offer particular advantages for the production of raw sausage, cooked sausage, boiled sausage, etc.

The demand for high-quality but also inexpensive food has led to the cutters used to produce it being constantly developed further from a hygienic and economic point of view. The largest cutters currently have a bowl capacity of more than 1000 liters in some cases and the blades used rotate at peripheral speeds of up to 180 m/s. The drive power of the largest machines is just under 400 kW.

The machine knives used are mounted in sets on a central blade shaft. Blade sets with 6 or 8 blades are often used for medium and large cutters. Regardless of the size, the knives must be able to transfer the motor power to the products to be shredded. The loads acting on the knives are correspondingly high (and increasing).

As a result, cutter knives can crack and, in the worst case, even break due to overloading. In some cases, this results in very high consequential damage.

The aim of the invention is to create machine knives, in particular cutter knives, which are better able to withstand stresses.

According to the invention, this objective is achieved with a machine blade which has a cutting body and a fastening section for fastening the cutting machine blade to a rotary drive. The cutting body has a central area defined by two lateral surfaces extending at least approximately parallel to one another and edge regions adjacent thereto, wherein the thickness of the cutting body decreases in a respective edge region starting from the central area towards a respective edge of the cutting body. In addition, the cutting body has at least one cutting edge with a cutting edge on a front edge of the cutting body in relation to a direction of rotation intended during operation. The machine blade is designed to be driven to rotate about an axis of rotation during operation. A radius of the machine blade extends from the axis of rotation to an outer edge of the machine blade.

According to the invention, the cutting body is free of openings or apertures over ⅗ of the radius starting from the axis of rotation and has one or more relief openings exclusively in the central area of the cutting body, all of which are arranged in an outer section of the central area extending beyond ⅗ of the radius.

The invention includes the realization that the load-bearing capacity of the machine blade cannot only be achieved by not adding material to highly stressed areas of the blade. Rather, the load-bearing capacity of the machine blade is increased by removing material from areas subject to low loads. This makes it possible to retain the blade contours available on the market, which have been optimized over many years to achieve high-quality frying properties with effective processing.

The invention includes the realization that the reduced material leads to lower centrifugal forces, which means that the material stresses can be reduced, especially in the back of the blade. Furthermore, the targeted removal of material in the form of perforations reduces the blade surface area, so that the counterforce component caused by the sausage meat pressing against it is also lower.

Cutter knives with openings have already been presented in the past. The aim was to increase efficiency and performance. For example, DE 10 2015 200 878 A1, EP 0 850 689 A1 and DE 20 2019 001 935 U1 disclose various cutter knives with openings or apertures. However, the arrangement of openings in cutter knives known from the prior art is not suitable for increasing their load-bearing capacity.

In order to further increase the load-bearing capacity of the cutting body and at the same time have a desired food technology effect on the material to be shredded, the edges surrounding the relief openings are preferably designed as follows:

Where there is high material stress during operation, in particular high material stresses, the edges are designed to minimize stress, in particular rounded. Where low material stresses occur during operation, the edges are designed with sharp edges for more effective sausage meat processing and thus have a technological function.

Preferably, the cutting body has a front edge area which extends in the direction of rotation towards the front edge with the cutting edge, whereby a grinding area is provided between the central area and the front edge area, in which the thickness of the cutting body does not initially decrease when the machine blade is still unused. The grinding area is provided so that the thickness of the cutting body in the grinding area belonging to the central area can decrease by grinding for resharpening the machine blade.

Preferably, the relief opening or the relief openings are round or oval.

Preferably, the smallest cross-sectional dimension of a respective relief opening is at least 6 mm.

Preferably, the number of relief openings is no more than 12 and preferably no more than 9.

The invention will now be explained in more detail with reference to embodiments shown schematically in the figures. The figures show:

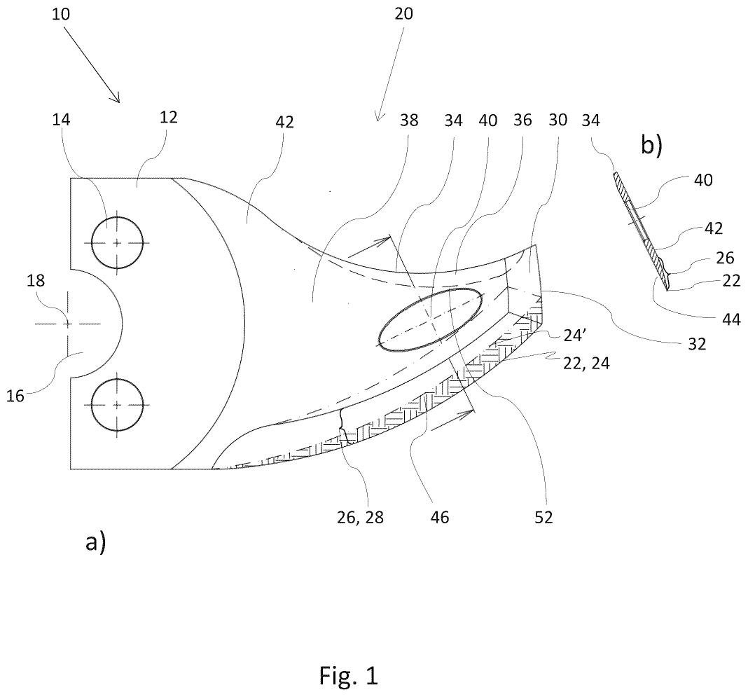

FIG. 1a-1b: a first variant of a machine blade according to the invention;

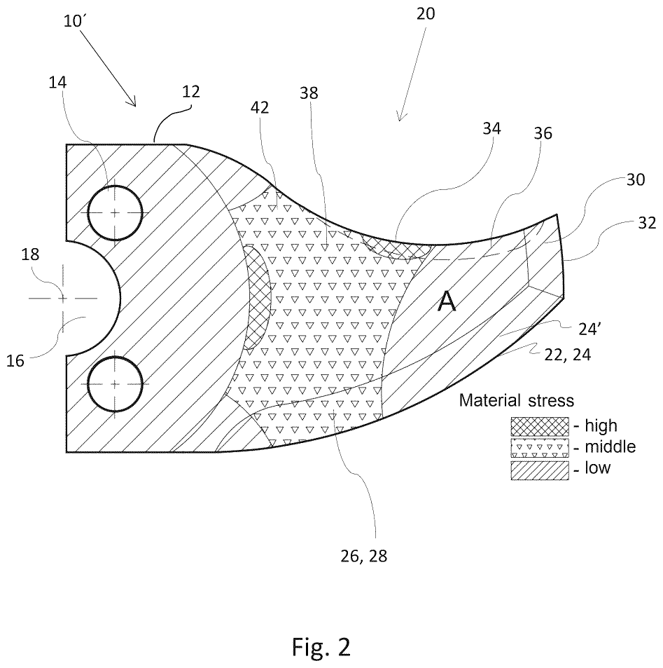

FIG. 2: An illustration of the stresses in a machine blade during operation;

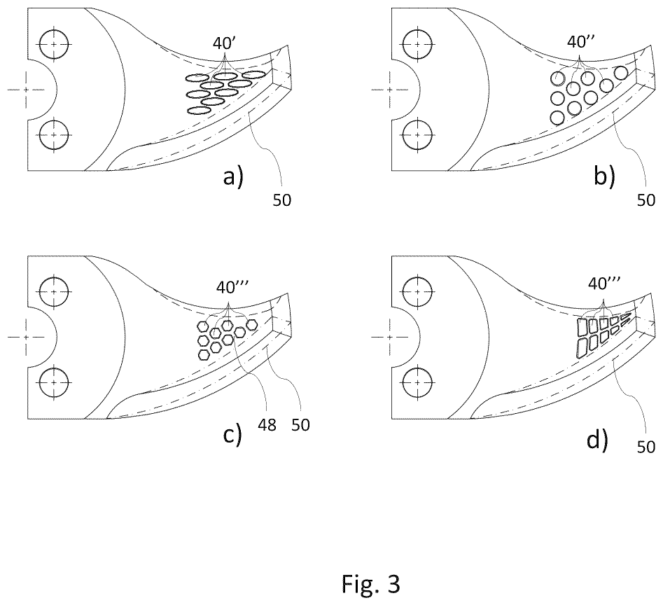

FIG. 3a-3d: further variants of a machine blade according to the invention; and

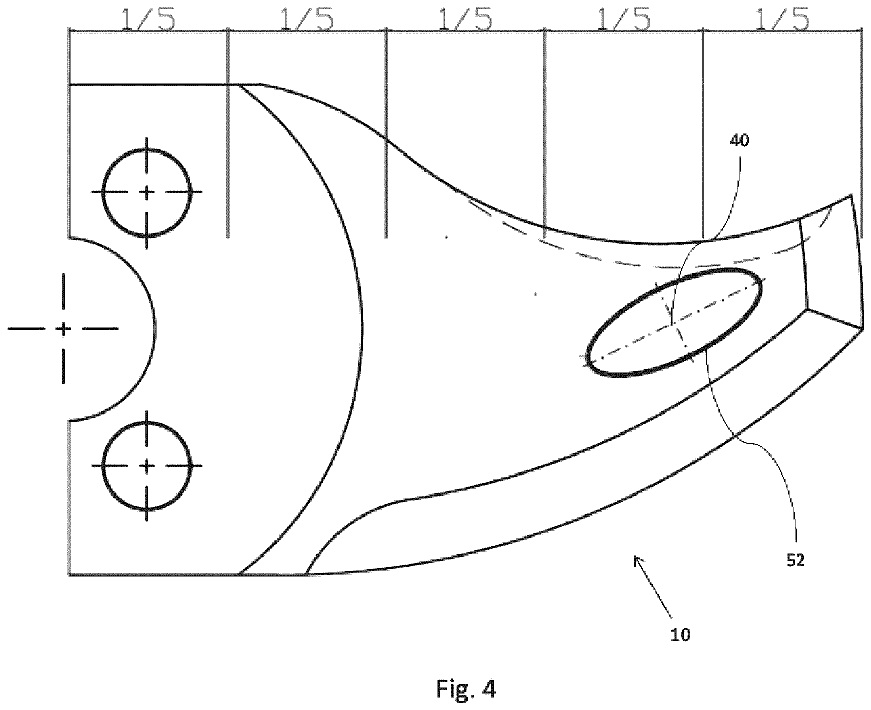

FIG. 4: a top view of the first variant of a machine blade according to the invention as shown in FIG. 1a;

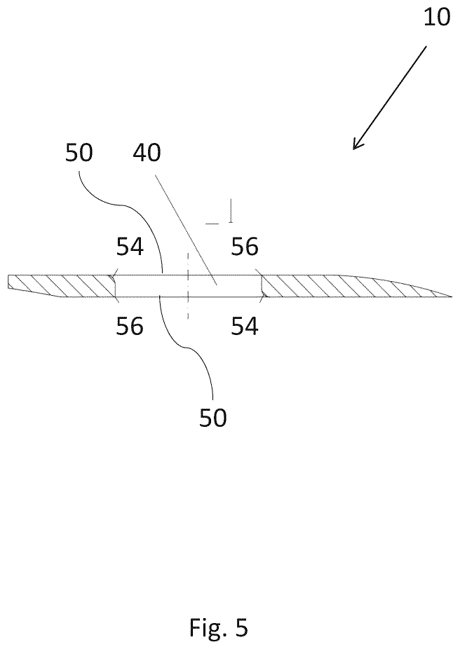

FIG. 5: a sectional view through the machine blade in the area of a relief opening to illustrate the different design of the edges surrounding the relief opening;

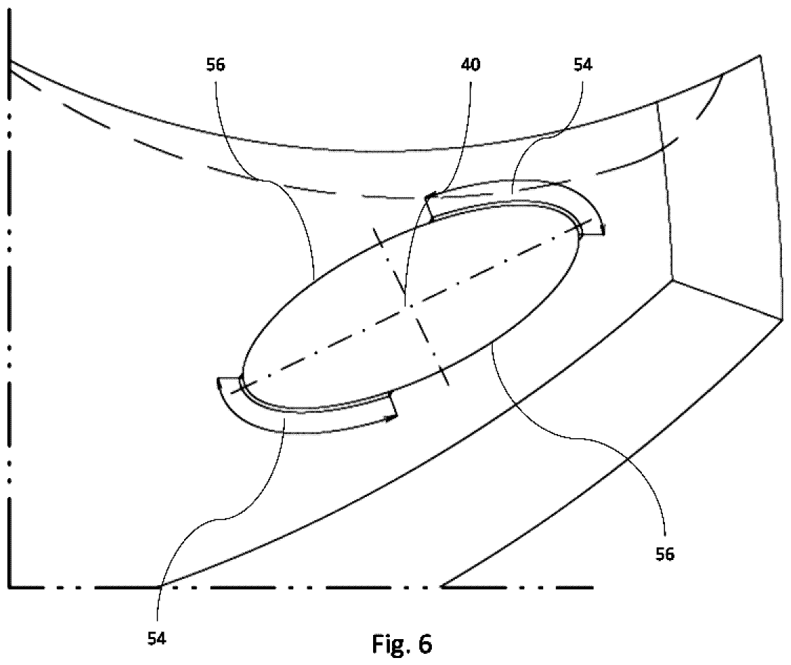

FIG. 6: a top view of a variation of the first variant of a machine blade according to the invention; and

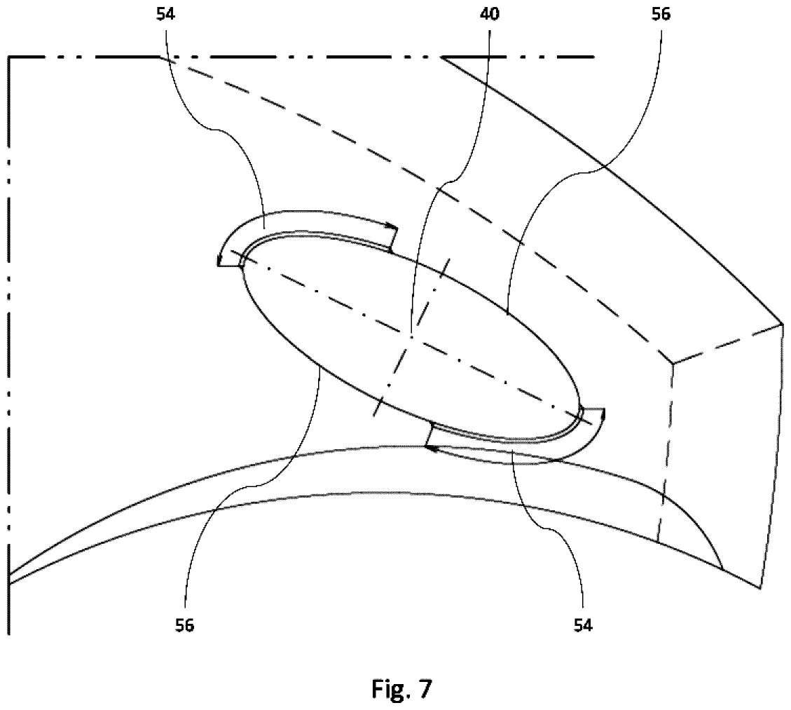

FIG. 7: a bottom view of the variation of the first variant of a machine blade according to the invention.

An example of a machine blade 10 in the form of a cutter blade with an opening 40 that increases the load-bearing capacity is shown in FIG. 1. FIG. 1a is a top view of the machine blade 10 and FIG. 1b is a cross-section through the machine blade 10 in the area of the opening 40 that increases the load-bearing capacity.

The machine blade 10 has a fastening section 12, which is used to fasten the machine blade 10 to a blade holder of a cutter. Two openings 14 are provided in the fastening section 12 for this purpose. During operation, a semi-circular recess 16 surrounds a drive shaft of the cutter, which rotates about an axis of rotation 18.

A cutting body 20 of the machine blade 10 adjoins the fastening section 12 in a radial outward direction. For cutting material to be minced, for example sausage meat, the cutting body 20 has a cutting edge 22 on its front edge 24. The cutting edge 22 forms the outer contour of a cutting bevel 26. In the area of the cutting bevel 26, the thickness of the cutting body 20 decreases as far as the cutting edge 22, with the transition preferably being crowned. The cutting bevel 26 thus forms a first edge region 28 of the cutting body 20. A further, outer edge region 30 ends in an outer edge 32 of the machine blade 10. The outer edge 32 is located in the radial end of the machine blade 10 remote from the fastening section 12. There is also a rear edge region 36 in the region of a rear edge 34 trailing the cutting edge 22 during operation, in which the cutting body 20 tapers slightly towards the rear edge 34.

In a central area 38, the cutting body 20 has a thickness that is largely uniform in the tangential direction and decreases slightly in the radial direction towards the outside, whereby the central area 38 is pierced by the relief opening 40. Except in the region of the relief opening 40, the central area 38 of the cutting body 20 is formed by two lateral surfaces 42 and 44 extending at least approximately parallel to one another. Preferably, the central area extends conically outside the fastening section 12, which terminates with the circular arc, up to the beginning of the crowned transition to the outer edge 32.

The outer edge area 30 and the rear edge area 36 are directly adjacent to the central area 38. The front edge area 28, which forms the cutting bevel 26, adjoins a grinding area 46, which can be gradually transformed into a cutting bevel during grinding for resharpening the machine blade 10. The dotted line 50 indicates the minimum contour remaining after repeated resharpening. In the area of the grinding area 46, the cutting body 20 also has the same thickness as the central area 38 when new. However, the grinding area 46 is not part of the central area 38 because the thickness of the cutting body 20 in the grinding area 46 can decrease when the machine blade 10 is resharpened. When resharpening the machine blade 10, material is removed in the area of the front edge 24 of the machine blade 10, so that the contour of the machine blade 10 in the area of the front edge 24 changes with each resharpening, resulting in a displaced front edge 24′. The machine blade 10 can be resharpened until the front edge 24′ follows a predetermined minimum contour. If the displaced front edge 24′ is in the area of the specified minimum contour, the machine blade 10 cannot be resharpened any further. The entire grinding area 46 is then also reworked into a-displaced-cutting bevel.

The relief opening 40 is arranged in an outer portion of the central area 38 of the machine blade 10 and is located between the bevel region 46 and the rear edge region 36 with respect to the direction of rotation of the machine blade 10. With respect to the radial direction of the machine blade 10, the relief opening 40 is located beyond three-fifths of the radius of the machine blade 10 starting from the axis of rotation 18.

In the embodiment shown in FIG. 1, the relief opening 40 is oval. The direction of the largest extension of the oval relief opening 40 extends at an angle of less than 30 degrees to a radius starting from the axis of rotation 18. The relief opening 40 has an elliptical shape with a long axis of symmetry, the length of which is approximately ⅓ to ⅕ of the dimension from the axis of rotation 18 to the outer edge 32 and which is three to five times longer than the short axis of symmetry.

The relief opening 40 is arranged in such a way that it is located in an area of the cutting body 20 in which lower material stresses prevail during operation.

FIG. 2 shows a machine blade 10′ similar to the machine blade 10 shown in FIG. 1, but without relief opening 40. FIG. 2 graphically shows areas with different material stresses that prevail in the machine blade 10 during operation in a cutter. In the area of the fastening section 12 and in an outer area of the cutting body 20, the material stresses are low during operation (hatching at 45°). The inventors have recognized that the areas of the cutting body 20 in which low material stresses prevail during operation are located beyond three-fifths of the radius of the machine blade 10′, starting from the axis of rotation 18. This area is marked with a capital A in FIG. 2. If the machine blade 10′ has a relief opening, such as the relief opening 40 in FIG. 1, in the central area of the area marked with capital A, this means that the material stresses in the areas of the cutting body 20 closer to the axis of rotation 18 are also reduced, so that the overall load-bearing capacity of the machine blade 10 is increased. In particular, one or more relief openings 40 can be used to reduce the stresses in those areas of the cutting body 20 in which high material stresses typically prevail during operation. These areas are shown in FIG. 2.

Typically, the material of the cutter blade is subjected to different loads during the cutter process. The load level depends on various factors such as the composition of the sausage meat, the temperature during filling and the temperature development during processing, the selected speeds, the changes in the properties of the sausage meat during the process, etc. etc. This shows that precise calculations and simulations of such tools are extremely demanding. However, it has been mathematically proven that the stress ranges shown in FIG. 2 tend to occur in a cutter blade.

Practical experience also shows that when tools are overloaded, material failure usually occurs in the highly stressed areas determined by calculations.

With the machine blades shown in FIG. 1 and in FIGS. 3a, b, c and d, the stresses in the cross-hatched zones are minimized. For this purpose, one or more relief openings are provided in the 45° hatched area (A). The stresses in the triangular hatched section are at a medium level and are unproblematic.

The blades shown in FIGS. 3a to 3d can also be subjected to significantly higher stresses and have a higher operational reliability due to material reductions in less stressed areas.

The elliptical relief opening 40 provided in the design example shown in FIG. 1 has the effect of reducing the centrifugal and acceleration forces. In addition, the rotary movement of the cutter bowl presses the sausage meat against the machine blade 10. This can flow through the relief opening 40 and thus minimize the lateral pressure on the machine blade 10.

The sum of both effects means that the material stress on machine knives 10 designed in this way is significantly lower. This results in greater safety with regard to the permissible material stress. Material fatigue will occur later and short-term overloads can be tolerated to a certain extent without damage.

The relief openings can be designed differently. The respective design depends on the shape of the cutter blade, the loads that occur and the optimization of the tension curves, taking into account the hygienic requirements for the tool that comes into contact with the food.

The embodiments according to FIGS. 3a to 3d show that instead of a single relief opening 40 as in the embodiment according to FIG. 1, a plurality of smaller relief openings 40′ (FIG. 3a), 40″ (FIG. 3b), 40″′(FIGS. 3c) and 40″″ (FIG. 3d) can be provided.

In the embodiments shown in FIGS. 3a to 3c, relief openings 40′ (FIG. 3a), 40″ (FIG. 3b) or 40″′ (FIG. 3c) are all the same size, the same shape and evenly distributed. The relief openings 40″″ (FIG. 3d) have different sizes, similar shapes and are arranged symmetrically.

In the embodiment according to FIG. 3a, a total of nine relief openings 40′ are provided, which are oval-specifically: elliptical-in shape. The long axes of symmetry of the elliptical relief openings 40′ all run parallel to each other and are aligned approximately parallel to the radial direction of the machine blade 10′. The ratio of long to short axis of symmetry of the elliptical relief openings 40′ is approximately 2 to 3. Instead of new relief openings 40′, 7, 8, 10, 11 or 12 relief openings 40′ can also be provided, which can also be more elongated or shorter.

FIG. 3b shows circular relief openings 40″ as a special case of elliptical relief openings. The number of these is also nine and the distribution is also similar or identical to the distribution of the elliptical relief openings 40′ from FIG. 3a. Instead of new relief openings 40″, 7, 8, 10, 11 or 12 relief openings 40″ can also be provided here.

In the embodiment according to FIG. 3c, a total of nine relief openings 40′″ are provided, which are hexagonal and are otherwise distributed similarly to the relief openings 40′ or 40″ in the embodiments according to FIGS. 3a and 3b. The hexagonal relief openings 40″′ are distributed evenly in such a way that the webs 48 remaining between them are all of the same width. This results in an even distribution of stress.

FIG. 3d shows 10 relief openings 40″″, which are arranged on the blade contour in such a way that they are located between the rear edge area 36 and the regrinding area up to the minimum contour 50. Between 1 and 15 relief openings 40″″ are practicable.

FIG. 4 illustrates in a plan view of the machine blade 10, analogous to FIG. 1a, that the opening 40, which increases the load-bearing capacity, extends beyond ⅗ of the radius of the machine blade 10.

FIG. 5 shows a sectional view through the machine blade 10 in the area of a relief opening 40, analogous to FIG. 1b, in order to illustrate the different design of the edges 52 surrounding the relief opening. In the section 54 in which there is high material stress during operation, in particular high material stresses, the respective edge 52 is designed to minimize stress, in particular rounded. In the section 56 in which low material stresses occur during operation, the edges 52 are sharp-edged as a impacting edge for more effective sausage meat processing and thus have a technological function.

FIGS. 6 (view from above onto the machine blade 10) and 7 (view from below onto the machine blade 10) show where the section 54, in which there is a high material stress during operation and the respective edge 52 is designed to minimize stress, in particular rounded, and where the section 56 can be located, in which low material stresses occur during operation and the edges 52 are designed with sharp edges as a impacting edge for more effective sausage meat processing.

The illustration in FIGS. 6 and 7 is exemplary. The areas 54 with increased load, which are shown identically at the top and bottom in FIGS. 6 and 7 as examples, can occur in different sizes and positions in the specific case. It is possible, for example, that in another embodiment an impacting edge (functional edge) and a rounded edge are opposite each other.

### LIST OF REFERENCE SIGNS

10 Machine blade
12 Fastening section
18 Axis of rotation
20 Cutting body
22 Cutting edge
24, 32, 34 Edge
26 Cutting bevel
28, 30, 36 Edge area
38 Central area
40, 40′, 40″, 40″′, 40″″ Relief opening
42, 44 Lateral surfaces
46 Grinding area
48 Web
50 Minimum contour
52 Edge enclosing a relief opening
54 Rounded section of the edge surrounding the relief opening
Section of the edge surrounding the relief opening acting as an impacting edge
RR Direction of rotation

What is claimed is:

1. A machine blade for food production, comprising a cutting body and a fastening portion for fastening the cutting-machine blade to a rotary drive,
wherein the cutting body has a central area defined by two lateral surfaces and edge regions adjacent thereto,
wherein a thickness of the cutting body decreases in a respective edge region starting from the central area towards a respective edge of the cutting body,
wherein the cutting body has at least one cutting bevel with a cutting edge at a front edge of the cutting body with respect to a direction of rotation intended in operation,
wherein the machine blade is designed to be driven in operation in rotation about an axis of rotation and a radius of the machine blade extends from the axis of rotation to an outer edge of the machine blade, and
wherein the cutting body, starting from the axis of rotation, is free of openings or apertures over ⅗ of the radius and in that the cutting body has one or more relief openings exclusively in the central area of the cutting body, all of which are arranged in an outer section of the central area which extends beyond ⅗ of the radius.

2. The machine blade according to claim 1, wherein at least some of the edges surrounding the relief openings are designed to minimize stress, in particular rounded, where there is high material stress during operation, in particular high material stresses.

3. The machine blade according to claim 1, wherein at least some of the edges surrounding the relief openings are sharp-edged where low material stresses occur during operation as a impacting edge for more effective sausage meat processing.

4. The machine blade according to claim 1, wherein in the cutting body has a front edge region which extends in the direction of rotation towards the front edge with the cutting edge, and in that a grinding area is provided between the central area and the front edge region forming the cutting bevel, in which the thickness of the cutting body does not initially decrease when the machine blade is still unused, the grinding area being provided so that the thickness of the cutting body in the grinding area, which is part of the central area, can decrease by grinding for resharpening the machine blade.

5. The machine blade according to claim 1, wherein the relief opening or the relief openings are round or oval, in particular elliptical.

6. The machine blade according to claim 1, wherein the relief openings are hexagonal.

7. The machine blade according to claim 1, wherein the relief openings are arranged along a respective blade contour.

8. The machine blade according to claim 1, wherein the smallest cross-sectional dimension of a respective relief opening is at least 10 mm.

9. The machine blade according to claim 1, wherein the number of relief openings is at most 15 and preferably not greater than 9.
